(19) United States
(12) Patent Application Publication
(10) Pub. No.: US 2006/0025006 A1
(43) Pub. Date: Feb. 2, 2006

(54) Cable retaining system

(76) Inventors: David Powell, Basingstoke (GB); Alan Peter Brown, Basingstoke (GB); William Mackenzie, Fleet (GB)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/184,479

(22) Filed: Jul. 19, 2005

(30) Foreign Application Priority Data
Jul. 29, 2004 (GB) GB 0416919.9

(51) Int. Cl. H01R 13/58

(52) U.S. Cl. 439/449

(57) ABSTRACT

A retaining system (1) that retains the front portion of a cable (7) in a connector housing (3). A sleeve device (21) has a base (25) with a hole (34) through which the cable extends, and has a pair of arms (27) with part-cylindrical inner surfaces that press against the cable to grip it. The arms have rear ends with recess (31). When the sleeve device is pushed fully forward into the connector housing, a bridging device (23) is pushed through an opening (15) into the housing. Legs (37) of the bridging element are inserted into the arm recesses (31) and prevent pull-out of the sleeve device and cable.

### CROSS-REFERENCE

Applicant claims priority from Great Britain patent application GB 0416919.9 filed 29 Jul. 2004.

### BACKGROUND OF THE INVENTION

This invention relates to a system for retaining an end of an electrical cable within a connector housing. Electrical connectors are widely used in modern voice and data communication networks. For example, a patch cord for use in a local area network comprises a length of cable having four twisted pairs of insulate wires within a cable jacket, and a pair of RJ45 connectors mounted at each end of the cable. Such RJ45 connectors are somewhat similar to small connectors at the ends of telephone cords that plug into wall sockets, but are commonly used to carry high frequency signals.

RJ45 connectors and other twisted pair connectors such as RJ11 connectors, commonly used a cable retention system in which a wedge shaped lateral bar is pushed through an opening in a wall of the connector housing and against the cable within the housing. The cable is thus trapped between the bar and a wall of the connector housing, and the cable is reliably and effectively retained within the connector housing. While such retention system is acceptable for voice communication networks and low bit rate data communication networks, it introduces a number of problems when used with high bit rate data communication networks.

First, in order to ensure effective retention of the cable, the lateral bar is often pushed onto the cable jacket with such a force that the individual wires within the cable are deformed, thereby altering the electrical properties of the wires. This problem is compounded by the wedge shape of the lateral bar, which concentrates all of the force along a narrow line. Even the moderate force required for effective retention of the cable causes some deformation of the wires, and consequent alteration in their electrical properties.

Alteration in the electrical properties of the wires caused by the prior cable retention system generally limits the maximum bit rate of data communication traffic that can be carried by the wires. Such a limiting effect is a problem because there are constant commercial and technological pressures for higher performance communication networks.

A further problem with the prior cable retention system is that, when the retained cable is tensioned, the resulting stress and strain are concentrated at the narrow line where the wedge shaped lateral bar contacts the cable. The resultant high levels of stress and strain also cause a detrimental alteration in the electrical properties of the wires, and also can lead to damage of the cable jacket and the wires. A hot melt adhesive may be injected into the connector during assembly to provide strain relief, but this operation requires additional machinery.

There is a need for a cable retention system, preferably using a connector housing largely similar to prior housings such as that shown in U.S. Pat. No. 6,517,377, that has a reduced effect on the electrical properties of wires within the cable and that minimizes stress and strain concentrations within the cable, in a simple and easily assembled construction.

### SUMMARY OF THE INVENTION

In accordance with one embodiment of the present invention, a connector is provided with a simple and easily assembled retaining system for retaining an end of an electrical cable within the connector housing, with minimum effects on the electrical properties of cable wires. The system includes a sleeve device having arms that grip opposite sides of the cable, and that slidable engage an inner surface of the connector housing when sliding into it. The retaining system also includes a bridging element for insertion through a bottom opening in the housing. The bridging element has a pair of legs that are inserted into recesses in the arms of the sleeve device.

In one embodiment of the invention, the arm recesses allow the legs of the bridging element to directly engage the cable. In another embodiment, the recesses allow the legs of the bridging element to press the arms of the sleeve device firmly against the cable.

The arms of the sleeve device contact the cable in a wide area to avoid concentrated forces. Where the legs of the bridging device directly engage the cable they also engage the cable over a considerable area to avoid concentrated forces.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an exploded isometric view of a connector of the invention.

FIG. 1A is an isometric view, showing the top of a connector of the prior art.

FIG. 1B is a sectional view taken on line 1B-1B of FIG. 1C, with the connector and cable fully assembled.

FIG. 1C is a sectional view taken on line 1C-1C of FIG. 1B.

FIG. 2 is an exploded isometric view of a connector of a second embodiment of the invention.

FIG. 3 is an exploded isometric view of a connector similar to that of FIG. 1, with a shield.

FIG. 4 is an exploded isometric view of a connector similar to that of FIG. 1 but with notches for overmolding with colored plastic.

FIG. 5 is a simplified plan view of a patch cord with ends of the types illustrated in FIGS. 1-2.

### DESCRIPTION OF THE PREFERRED EMBODIMENTS

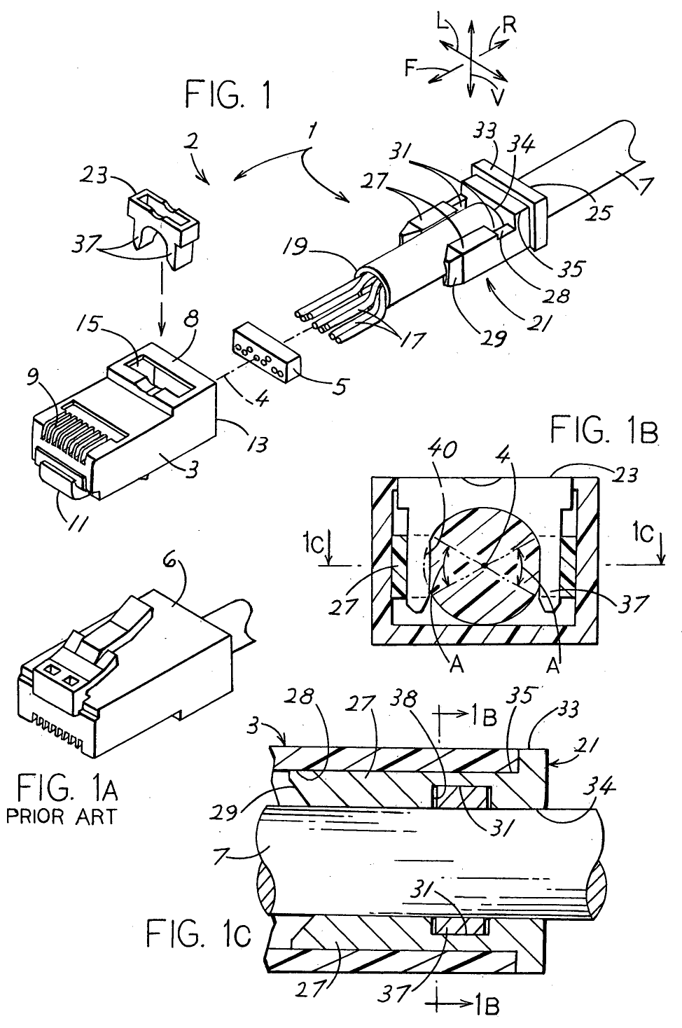

FIG. 1 shows a connector 2 and cable 7, the connector including a retaining system 1 according to the invention. The connector has a connector housing 3 and a loadbar 5 extending along an axis 4, with the cable also extending along the axis. The connector housing 3 is that of a standard RJ45 connector housing having eight contacts 9 and a locking mechanism 11. FIG. 1A shows what may be considered the top wall 6 of such a prior art connector, and FIG. 1 shows what may be considered the bottom wall 8. The connector housing 3 is molded from plastic and forms a thin walled enclosure having a rectangular cross section. A rear end 13 of the connector housing 3 (along rearward arrow R) is open to receive the retention system 1 and the cable 7. The bottom surface 8 of the connector housing has a laterally (arrow L) elongated opening 15. The opening 15 is closer to the open rear end 13 of the connector housing than to its front end.

The cable 7 comprises four twisted pairs of insulated wires surrounded by a cable jacket 19. The cable jacket 19 has a substantially circular cross section. In the example, the cable is used for carrying high bit rate data signals. The loadbar 5 is a molded plastic component having eight holes, one for each of the wires 17. The loadbar 5, which is known, staggers the wires so that they can be accurately terminated to the contacts 9.

The retention system 1 includes a sleeve device 21 and a bridging element 23. In the example, the sleeve device 21 is a single molded plastic part, although it could be formed of a plurality of parts. The sleeve device has a base 25 and a pair of laterally spaced arms 27 extending forwardly F from the base. The outer surfaces (surfaces furthest apart and furthest from the axis 4) of the arms 27 are substantially flat and parallel for engaging inner surfaces 28 (FIG. 1C) of the connector housing. The arm front ends 29 are bevelled to ease their insertion into the connector housing 3. The inner surfaces 40 (FIG. 1B) of the arms 27 have forward portions with part circular cross sections for gripping large areas at opposite sides of the cable 7, by angles 2A that together are preferably at least 90°. In the example, the cable contacting part of the inner surface is 6 mm long.

Locating recesses 31 (FIGS. 1 and 1C) are formed in the inner surfaces of the cable-engaging arms 27. The locating recesses 31 are 1.8 mm deep (in the lateral L direction), and extend along a full vertical V depth of the arms. The locating recesses 31 causes a reduction in the cross sectional area of rear parts of the arms 27, resulting in greater flexibility. In the example, locating cutouts 28 are also provided in the top surface of the longitudinal arms 27 beside the recesses, to a depth of 0.3 mm (in the vertical direction).

The locating recesses 31 are aligned with laterally L opposite sides of the opening 15 in the connector housing 3. A front part 35 of the base fits tightly into the connector housing. This provides accurate location of the arms 27. The tight fitting also provides an effective seal between the connector housing 3 and sleeve device. The rear part peripheral 33 of the base lies flush with the outer surface of the connector housing 3 when the sleeve device has been received into the connector housing.

The bridging element 23 is a molded plastic component having a pair of laterally spaced legs 37. The bridging element 23 is constructed to be inserted perpendicular to axis 4 into the opening 15 in the connector housing 3 after the sleeve device 21 has been inserted. The legs 37 of the bridging element are intended to pass into the locating recesses 31 in the arms 27 of the sleeve device. The inner surfaces of the bridging legs 37 are adapted to grip opposite sides of the cable 7. In the example, the bridging element 23 is color coded red to identify the data traffic that is being carried by the cable 7.

In use, the end of the cable 7 is slid forwardly F through a hole 34 (which may have a gap) in the sleeve device and the loadbar 5 is assembled onto the individual wires 17 at the end of the cable 7. The end of the cable 7 and the loadbar 5 are then inserted into the connector housing 3. The loadbar 5 and the wires 17 are conventionally located and connected within the connector housing 3. Once the wires 17 have been connected, the sleeve device 21 is slid forwardly along the cable towards and into the connector housing 3 until the rear part 33 of the base abuts the rear end of the connector housing.

Once the sleeve device 21 is installed, the bridging element 23 is inserted into the opening 15 in the connector housing. The bridging element is inserted until the bottom, or outside surface of the bridging element 23 is flush with the outer surface of the connector housing 3. The laterally spaced legs 37 of the bridging element are inserted into the locating recesses 31 that lie between the cable 7 and the longitudinal arms 27 of the sleeve device. The legs of the bridging element lock the sleeve device 21 in place in the connector housing 3 by abutting rearwardly-facing shoulders 38 (FIG. 1C) on the sleeve device arms. The legs of the sleeve device lie in interference fits with the cable, to provide extra gripping force on the cable. Such interference also prevents the bridging element from falling out. However, much cable gripping force is due to the inside surface 28 of the connector housing pressing front portions of the arms against the cable. The gripping force at the legs 37 on the cable prevents the bridge device from falling out.

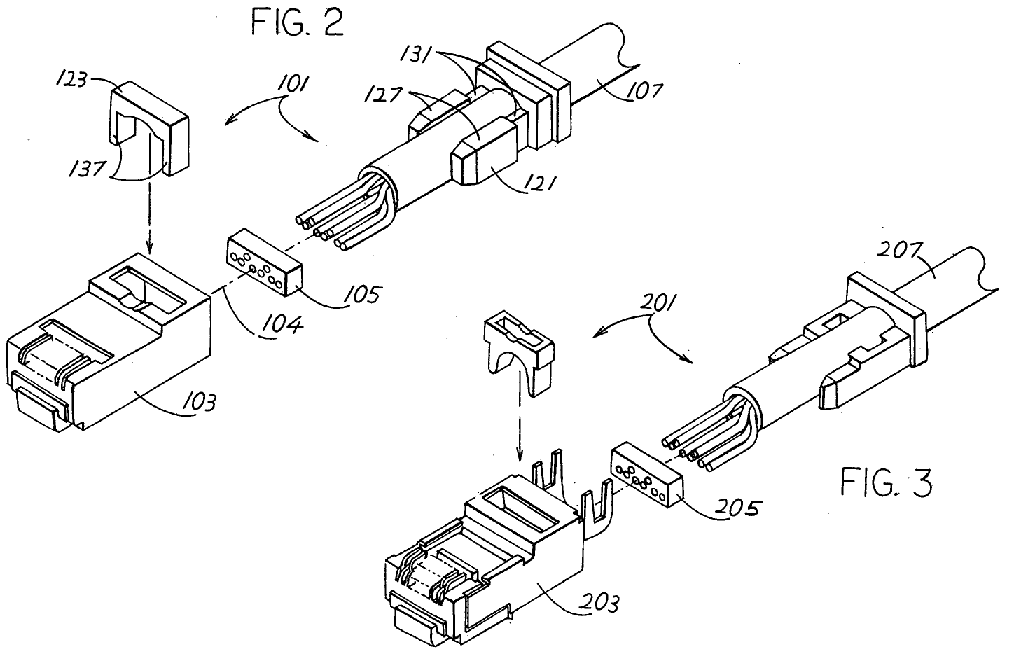

FIG. 2 shows a second retaining system 101 of the invention, together with a connector housing 103, loadbar 105 and cable 107 located on an axis 104, and that are the same as those shown in FIG. 1. The sleeve device 121 is the same as that shown in FIG. 1 except that the locating recesses 131 are formed in the outer surfaces of the sleeve device arms 127. The bridging element 123 is similar to that shown in FIG. 1 except that the transverse arms 137 are adapted to fit into the locating recesses 131 in the outer surfaces of the longitudinal arms 27.

The retaining system of FIG. 2 is assembled in the same way as that shown in FIG. 1. However, the legs 137 of the bridging element 123 are inserted into the locating recesses 131 of the sleeve device arms. The fully inserted legs lie between the inner surface of the connector housing 103 and the arms 127 of the sleeve device. The bridging element legs lock the sleeve device 121 in place in the connector housing 3. Although the bridging element 123 provides no additional gripping force on the cable 107, the sleeve device arms 127 are in contact with a greater length of the cable.

FIG. 3 shows a third example of a retaining system 201 according the present invention, together with a connector housing 203, a loadbar 205 and a cable 207 having a longitudinal axis. The retaining system 201, the loadbar 205 and the cable 207 are the same as those shown in FIG. 1. The connector housing 203 is the same as that shown in FIG. 1, except that it is for a shielded connector.

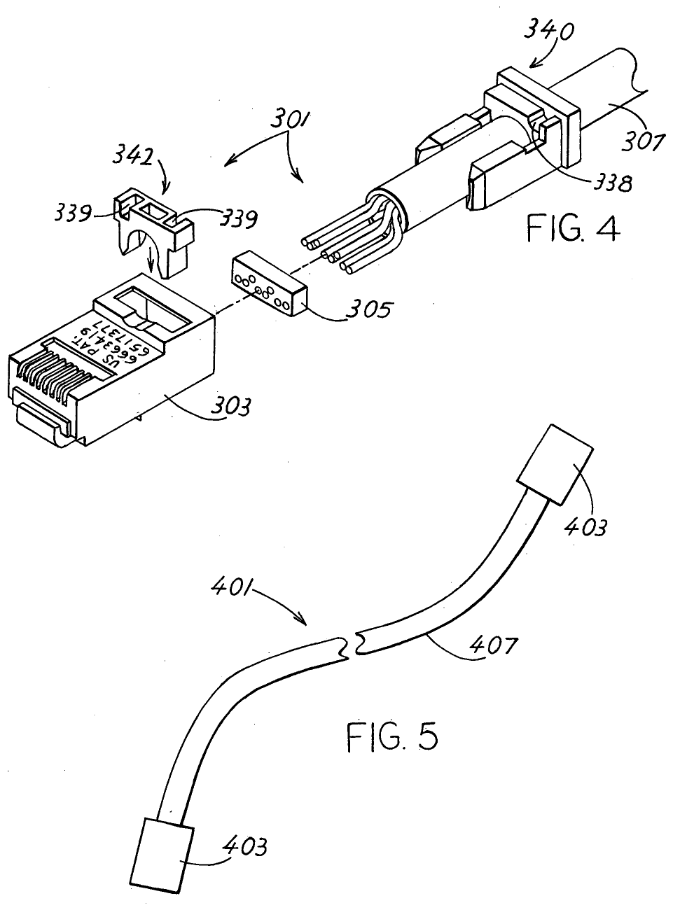

FIG. 4 shows a fourth example of a retaining system 301 according to the present invention, together with a connector housing 303, a loadbar 305 and a cable 307. The connector housing 303, the loadbar 305 and the cable 307 are the same as those shown in FIG. 1. The retaining system 301 comprises a sleeve device 340 and a bridging element 342 that are the same as those shown in FIG. 1, except that they include complimentary notches 338, 339 in their top surfaces. It is common to overmold a connector with material of a specific color that identifies the type of signals being carried. A key may be over-molded in the notches 338, 339 and the notches then prevent ingression of colored over-mold material into the connector. Ingression of over-mold material is disadvantageous in that it may disturb the layout of the internal wires and hence disturb the electrical characteristics of the connector. Over-molding allows for color coding of the connector, and also for the attachment of the additional components. Over-molding also allows for the various components of the connector to be reliably, securely and/or irreversibly locked together.

FIG. 5 shows an example of a patch cord 401 according to the invention. The patch cord 401 comprises a cable 407 terminated at each end with an RJ45 connector 403. The RJ405 connectors 403 each include the cable retention system described above with reference to FIG. 1, including the connector housing 3. The retention system of the invention is particularly suitable for patch cords used in high bit rate data communication networks.

Various modifications to the retention system of the invention will be apparent to those skilled in the art. For example, connectors other than RJ45 connectors may be used. The retention system is also applicable to different types of cable, such as coaxial cable and power cables.

While terms such as “top”, “bottom”, etc. have been used to describe the invention as it is illustrated, the invention can be used in any orientation.

The novel features of the invention are set forth with particularity in the appended claims. The invention will be best understood from the following description when read in conjunction with the accompanying drawings.

What is claimed is:

1. A connector and cable combination wherein the connector has a housing with rear and front portions and with a rear opening lying on an axis, the connector having a plurality of contacts mounted in the housing that are connected to wires of said cable, said cable having a front end that extends forwardly into said housing through said rear opening, the housing having a bottom opening extending upward into said housing rear portion, including:
a sleeve device that includes a rear part with a base having a hole through which the cable extends, said sleeve device having a pair of arms projecting forwardly from said base and lying on opposite sides of said cable, said arms each having a rear portion forming a recess that extends perpendicular to said axis;
said sleeve device lying in said housing rear opening;
a bridging element which extends into said bottom opening, said bridging element having a pair of legs projecting perpendicular to said axis with each leg lying in one of said recesses.

2. The connector described in claim 1 wherein:
said recesses in said pair of arms lie on inner sides of the arms that are closest to said cable;
said legs of said bridging element are spaced apart to lie in said recesses and press directly against opposite sides of said cable to prevent rearward sleeve device pullout, while front portions of said arms that lie forward of said recess press directly against opposite sides of said cable.

3. The connector described in claim 1 wherein:
said recesses in said pair of arms lie in outer sides of the arms that are furthest from said cable;
said legs of said bridging element are spaced apart to lie in said recesses.

4. The connector described in claim 1 wherein:
said housing has side wall with internal surfaces that press directly against outer surfaces of first portions of said arms to press said arms against said cable.

5. A connector that has a housing with front and rear housing portions said rear housing portion having a rear opening for receiving a front portion of a cable of round cross section and of predetermined diameter, the housing also having a bottom opening extending upward into said housing rear portion, including:
a sleeve device with a base having a hole with an axis through which said cable is designed to extend, said sleeve having a pair of arms projecting forwardly from said base for lying on opposite sides of the cable, each arm having inner and outer sides lying respectively closest and furthest from said axis, and each arm forming a rearwardly-facing shoulder;
a bridging element that projects up into said bottom opening, said bridging element having a pair of upwardly-extending legs with leg inner sides that are spaced to lie at opposite sides of said cable, and with leg forward surfaces that lie against said rearwardly-facing shoulders to limit rearward movement of said sleeve device.

6. The connector described in claim 5 wherein:
said arms of said sleeve device have front end portions that are spaced to press against opposite sides of said cable, and said arms have rear portions with inner sides that are spaced far enough apart to leave a gap between the cable and the inner side of each arm rear portion; said legs of said bridging element are formed to pass into said gaps, and said legs have inner surfaces that are spaced to from an interference fit with the cable.

7. The connector described in claim 5 wherein:
said housing has opposite walls that keep said arms pressed against said cable.

8. A connector that has a housing with front and rear housing portions said rear housing portion having a rear opening for receiving a front portion of a cable of round cross section and of predetermined diameter, the housing also having a bottom opening extending upward into said housing rear portion, including:
a sleeve device with a base having a hole with an axis through which said cable is designed to extend, said sleeve device having a pair of arms projecting forwardly from said base for lying on opposite sides of the cable, each arm having inner and outer sides lying respectively closest and furthest from said axis, and each arm having a rearwardly-facing shoulder;
a bridging element that projects up into said bottom opening, said bridging element having a pair of upwardly-extending legs with forwardly-facing surfaces that engage said shoulders on said arms.

9. The connector described in claim 8 wherein:
said legs press against opposite sides of said cable in an interference fit therewith.

10. The connector described in claim 8 wherein:
said legs press against opposite outer sides of said legs in an interference fit therewith.
